(19) United States
(12) Patent Application Publication
(10) Pub. No.: US 2020/0062143 A1
(43) Pub. Date: Feb. 27, 2020

(54) ELECTRIFIED ROAD TRANSPORT SYSTEM

(71) Applicant: SIEMENS MOBILITY GMBH, MUENCHEN (DE)

(72) Inventors: FLORIAN BUEHS, BERLIN (DE); HENRIK ENGDAHL, ASKIM (SE); OLIVER GRAEBNER, NEUSTADT A.D. AISCH (DE); GOERAN SAENGER, BERLIN (DE); MICHAEL LEHMANN, ERLANGEN (DE)

(21) Appl. No.: 16/487,650

(22) PCT Filed: Feb. 2, 2018
(86) PCT No.: PCT/EP2018/052675

§ 371 Date: Aug. 21, 2019

(30) Foreign Application Priority Data
Feb. 21, 2017 (DE) 10 2017 202 757.6

(51) Int. Cl. B60M 1/12; B60M 1/18; B60M 1/20; B60L 5/20

(52) U.S. Cl. CPC B60M 1/12; B60L 5/20; B60M 1/20; B60M 1/18

(57) ABSTRACT

An electrified road transport system includes a contact line system having a plurality of masts with support cables and contact wires suspended thereon. The contact line system has structural modifications for reducing the horizontal and/or vertical positional tolerances of the contact wires. In the context of the structural modifications, section separators are fastened directly to masts or to cantilevers of the masts, skewed overhead lines are disposed in straight section segments and/or in curves, and the support cables and/or contact wires have smaller cross-sections and/or higher longitudinal tensile forces. A method for stabilizing a contact line system of an electrified road transport system is also provided.

The invention relates to an electrified road transport system. The invention also relates to a method for stabilizing a contact line system of an electrified road transport system.

Electric transport systems for transporting goods and persons, having contact lines for supplying electrical energy to vehicles are used in many different variants. Two-pole overhead line systems fed with direct current are conventionally used when using lane-bound supply systems for non-rail-bound vehicles. These have the advantage of a smaller space requirement for the vehicle components and increased safety. The two-pole overhead lines are arranged above electrified traffic lanes and are contacted by electrified utility vehicles with the aid of actively readjusting current collectors, also called pantographs. With the aid of the actively readjusting current collectors, considerable variations, caused by structural system features or temporary environmental conditions, in the horizontal and vertical position above the lane are compensated in comparison to the nominal position.

Horizontal positional deviations between the vehicle and the contact line can result, for example, from a lateral offset of the contact lines with respect to the center of the lane due to chord formation of the contact lines between two adjacent line masts in curves. This results in zig-zag patterns of the course of the contact lines. If the section separators are held by the support cable, then only vertical chain mechanisms are supported in curves, so a zigzag course is formed in the curves, because in order to hold the weight of the section separator, the support cable carrying the section separator has to be arranged directly above it. If in a parallel span there is a change in the contact wires, a lateral offset is produced between the two contact wires. A time-varying offset can be achieved, for example, by a wind power take-off of the contact line in the case of a side wind. In addition, positional deviations due to structural tolerances can also result. Horizontal positional deviations between contact lines and vehicles can also result, however, due to a variable lateral positioning of the vehicle within an electrified lane.

Vertical positional deviations between vehicle and contact line can result from the inertia in the height compensation by means of a non-ideal efficiency of what are known as wheel tensioners and by restoring forces to be overcome at the cantilevers of the power masts. Reduced installation heights of the contact wires result across the road in the case of the continuous electrification on low structures. Utilization of the contact wires, additional loads owing to icing of the contact wires or dimensional tolerances can also lead to a vertical positional deviation.

The horizontal and vertical positional deviations are conventionally compensated by an active horizontal and vertical adjustment of the current collector. A further measure is the use of correspondingly wider carbon wearing strips on the current collectors, which, however, are only worn to a greater extent in a narrow region. This results in a shorter service life of the wearing strips, and this is associated with higher operating and maintenance costs.

In addition, further requirements consist in that the current collector, with travel on non-electrified sections, has to be securely retracted within the horizontal and vertical perimeters of the vehicle in order to rule out contact with other vehicles or structural infrastructure. This results in a significant complexity of the current collector architecture in respect of degrees of freedom, actuators, sensors, control components, which lead to high costs and to a high weight of the current collector.

In Siemens AG, TU Dresden, DLR: ENUBA 2—Gemeinsamer Abschlussbericht [Joint Final Report]; version V3 dated Aug. 31, 2016 contact lines are designed to be skewed in curves. There is also a lowering of the support cable at directional gantries.

Siemens AG: “Mit eHighway in die Zukunft” [Into the future with eHighways]; brochure, 2012 describes an electrified road transport system in which specially adapted overhead lines are installed for speeds of up to 90 km/h.

Kiessling, F: PUSCHMANN, R; SCHMIDER, A.: Fahrleitungen elektrischer Bahnen [Contact lines of electric trains], 3^{rd} edition Erlangen: Publicis Publishing, 2014. Page 126.—ISBN 978-3-89578-407-1 describes the problems of deflection of contact wires by external influences and the stability of the support elements.

DE 10 2011 080 887 A1 describes overhead lines for local transport trains with section separators in the region of overhead line masts.

Powerlines Products GmbH: Powerlines Product Catalogue, section 10.1/1.1, issue 6/2014 Powerlines Products GmbH: Powerlines Product Catalogue. D-45329 Essen, 6/2014. Section 10.1/1.1—company literature, specifies limit values, which must not be exceeded in the event of wear of contact wires.

BUCHHOLD, TH; TRAWNIK, F: Die elektrischen Ausrüstungen der Gleichstrombahnen [The electrical plant of direct current railway systems]. Berlin; Julius Springer, 1931. Pages 292-308.—ISBN 978-3-642-89467-1 describes the application of skewed contacts lines in curves and semi-skewed chain contact lines on straight sections.

One problem is therefore to develop an electrified road transport system, in which positional deviations between vehicle and contact wire are compensated or reduced with less effort.

This object is achieved by an electrified road transport system as claimed in claim 1 and by a method for stabilizing a contact line system of an electrified road transport system as claimed in claim 9.

The inventive electrified road transport system has a contact line system having a plurality of masts and overhead lines suspended on the masts, which comprise support cables and contact wires suspended thereon, and at least one electrified transport vehicle having a pantograph. As is customary, a pantograph should be taken to mean a current collector mounted on a vehicle. An electrified road transport system should be taken to mean a transport system in which the transport vehicles in question travel in a non-rail-bound manner on a route and draw electric current bound in a lane-bound manner. In this case, in contrast to rail-bound systems, lane changes are possible at any time, wherein, however, as a rule, the contact with the power supply line is interrupted for a short period of time. The contact line system has structural modifications for reducing the horizontal and/or vertical positional tolerances of the contact wires. The structural modifications comprise section separators fastened directly to masts or cantilevers of the masts and skewed overhead lines in straight section segments and/or in curves and support cables and/or contact wires having smaller cross-sections and/or higher longitudinal tensile forces.

If the line separators are suspended directly on the masts or cantilevers, it is also possible to install skewed contact lines in curves, and this is associated with an improved positional stability of the contact wires. If cross-sections of the support cables and/or the contact wires are reduced, they offer a smaller target for side winds. Less susceptibility to side winds is accompanied by a smaller deviation of the contact wires from a rest position.

The reduction in the horizontal and/or vertical positional tolerances of the contact wires allows a simplified construction of the current collectors used for electrified road vehicles because, owing to the smaller variation of the relative position of the contact wires to the pantographs of the electrified vehicles, it is possible to reduce demands on the mechanical adjustment of the position of the pantograph to the position of the contact wires. Owing to the lower structural demands on the design of the pantograph, the complexity of the pantograph can be reduced, the number of components thereof can be reduced, the complexity of production of the pantograph can be reduced and a lower maintenance requirement and a longer service life of the pantograph can be achieved. The above-mentioned advantages also contribute to a reduction in the costs of production and operation of an electrified road transport system.

In the inventive method for stabilizing a contact line system of an electrified road transport system, which has a plurality of masts and overhead lines suspended on the masts, which comprise support cables and contact wires suspended thereon, and at least one electrified transport vehicle having a pantograph, structural modifications are made to reduce the horizontal and vertical positional tolerances of the contact wires. Within the framework of the structural modifications section separators are fastened directly to masts or cantilevers of the masts. Skewed overhead lines are installed in straight section segments and/or in curves and support cables and/or contact wires having smaller cross-sections and/or higher longitudinal tensile forces are installed.

The inventive method inventive shares the advantages of the inventive electrified road transport system.

The dependent claims and the following description each contain particularly advantageous embodiments and developments of the invention. In particular, the claims of one claim category can also be developed analogously to the dependent claims of another claim category. Furthermore, within the scope of the invention, the various features of different exemplary embodiments and claims can also be combined to form new exemplary embodiments.

In a preferred embodiment of the inventive electrified road transport system, the structural modifications comprise at least one of the following features:
the contact line system comprises additional line feeders on the masts,
the anchoring devices of the contact wires are designed as two-span anchoring devices without parallel spans.

Increasing the longitudinal tensile forces in the support cables and/or contact wires compared to conventional arrangements also contributes to a reduced variation in the position of the contact wires. So the support cables and/or contact wires withstand the higher tensile forces, it is possible, for example, to select and optimize materials in respect of improved tensile strength. The use of additional line feeders on the masts permits compensation of a weaker electric current flowing as a result of the smaller cross-section of the contact wires and support cables, with part of the electric current flowing through the line feeders. If the anchoring devices of the contact wires are formed as two-span anchoring devices without parallel spans, a lateral offset of the contact wires occurring in parallel spans is thus avoided. In this way, corresponding tolerances in the lateral direction during current tapping can be reduced.

In one embodiment of the inventive transport system, in section segments having skewed overhead lines, the mast distances are unchanged in the section direction compared to mast distances in the case of straight-running overhead lines, so, compared with an arrangement with straight-running overhead lines, reduced horizontal and/or vertical positional tolerances of the contact wires result. In the case of conventional straight-running overhead lines, it is customary to use mast distances in the section direction of approximately 60 m. In the case of an unchanged demand on the positional tolerances of the overhead lines and the contact wires and support cables, mast distances of up to 110 m would accordingly be possible when using skewed overhead lines. In this embodiment, the mast distances should instead be maintained, so, as a result of the better rigidity of the overhead lines owing to the skewed arrangement of the overhead lines, reduced horizontal and/or vertical positional tolerances of the contact wires result compared to a conventional arrangement.

In a special variant of the inventive electrified road transport system, an electrified transport vehicle has a pantograph, which has a reduced working range. The reduced working range, preferably a reduced vertical working range, enables a more uniform current collector run, fewer contact force jumps, reduced wear and therewith, in turn, a longer service life and reduced operating costs of the pantograph. A working range of a conventional pantograph in a conventional electrified transport system should be assumed as a comparison variable for the reduced working range.

The pantograph can also have a horizontal working range which is reduced compared to conventional pantographs. The working range (vertical, horizontal) is the range which the current collector can assume or actively control. Therefore, in this variation a change in the position of the pantograph in the transverse direction is limited. Advantageously, fewer actuators, lower control dynamics up to the elimination of an entire degree of freedom are possible in this embodiment for covering a smaller horizontal working space. Advantageously, it is thereby possible to reduce the complexity of the construction of the current collector.

In a special embodiment of the inventive electrified road transport system the pantograph of the electrified transport vehicle has a reduced positional tolerance. The width of the possible contact area of the current collectors can be reduced, for example, since the possible variation in the positions of the contact wires is limited.

Positional tolerances should in this connection be taken to mean permitted positional deviations of the contact wires. These result from structural tolerances and mechanical effects in the system (wheel tensioner), the wear of the contact wire, vertically acting ice loads and horizontally acting wind loads.

The positional tolerances therefore define a space in which the contact wires are to be expected. This space must be smaller than or equal to the working space of the pantograph so the pantograph can always reliably contact the contact wire.

In a variant of the inventive electrified road transport system the pantograph assumes an invariable position in the lateral and/or vertical direction. In this variant, the technical outlay for the production, maintenance and operation of such a pantograph is particularly low.

In one embodiment of the inventive electrified road transport system the pantograph has a passive air spring system and/or a passive mechanical spring system for vertical position adjustment. A passive spring system has a considerably lower degree of complexity and susceptibility than a controlled pneumatic system used to control the position and movement of a conventional pantograph.

In one embodiment of the inventive electrified road transport system the electrified transport vehicle has an automatic switching device for changing the energy supply of the electrified transport vehicle, which is triggered in the event that the pantograph of the electrified transport vehicle no longer has a secure contact with the contact wire. An automatic switching device of this type is particularly useful when reducing the operating range of the pantograph. The automatic switchover can be carried out, for example, as a function of continuously updated measurement information, which is detected by sensors or is determined by a direct current/voltage measurement. This can therefore comprise either directly the current flow which is present or indirect measurement information, for example in respect of a wind speed or the like. Advantageously, it is possible to thereby compensate for short-term undesired separations of the contact between the pantograph of the transport vehicle and the contact wires such that the switching device switches from a power supply via the pantograph to an energy supply of the vehicle, in particular the traction system, by means of an energy store inside the vehicle. An energy supply inside the vehicle can be achieved, for example, with the aid of an accumulator and/or by the connection of an internal combustion engine. In spite of a reduction in the operating range of the pantograph, and thus a limited adaptation of the position of the pantograph to a variation in position of the contact line, a constant energy supply to the transport vehicles used can be ensured in this way.

The invention will be explained in more detail in the following with reference to the accompanying figures on the basis of exemplary embodiments. In the drawings:

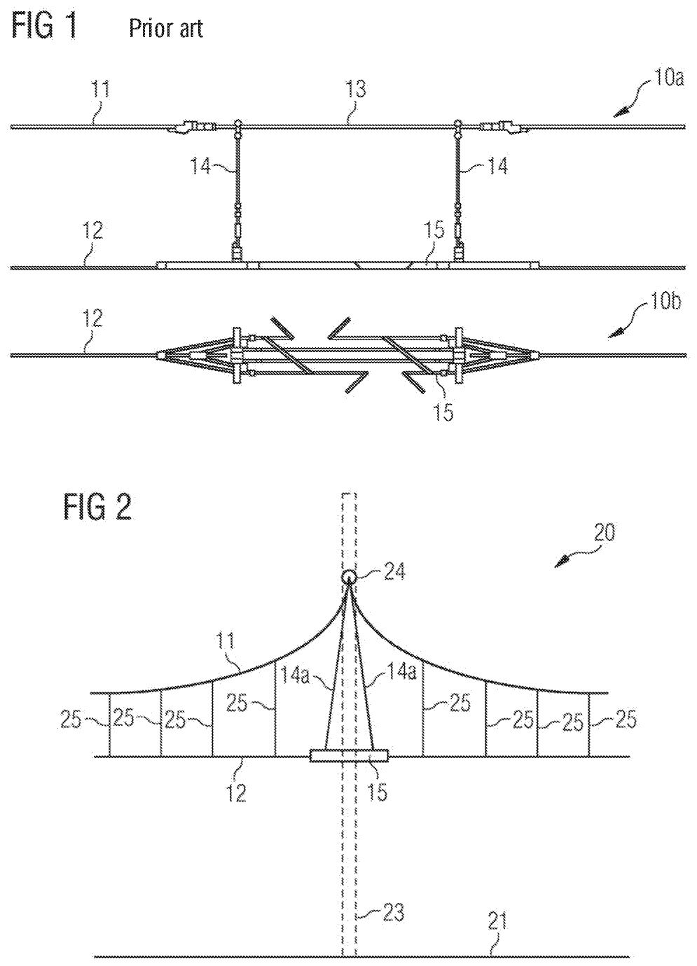

FIG. 1 shows a side view and a plan view of a section separator,

FIG. 2 shows a side view of an arrangement of a section separator according to one exemplary embodiment of the invention in a curve,

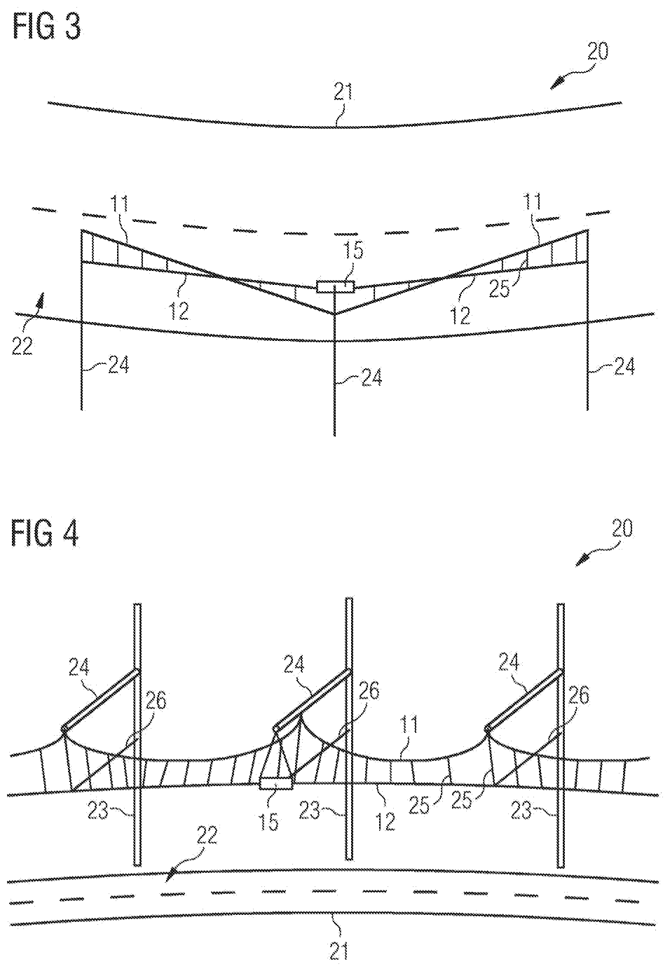

FIG. 3 shows a plan view of the arrangement shown in FIG. 2,

FIG. 4 shows a perspective view of the arrangement shown in FIG. 2 and FIG. 3,

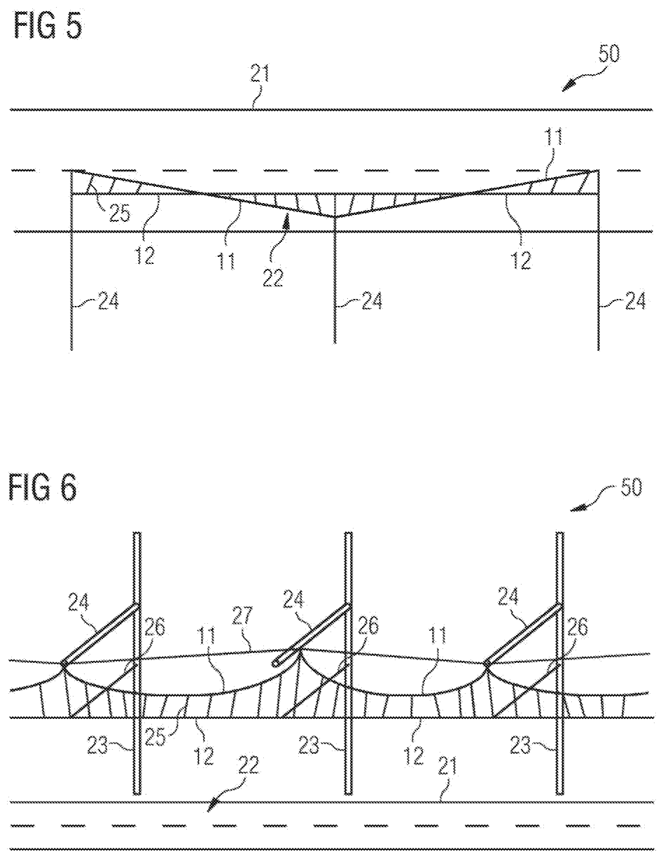

FIG. 5 shows a plan view of an arrangement of an overhead line according to one exemplary embodiment of the invention over a straight-running road,

FIG. 6 shows a perspective view of the overhead line arrangement illustrated in FIG. 5,

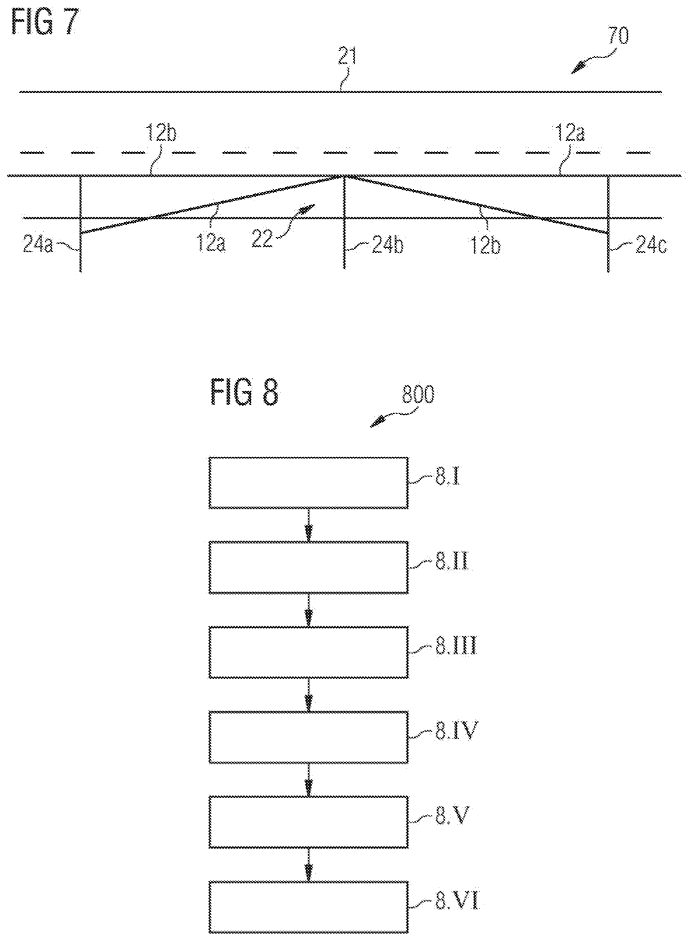

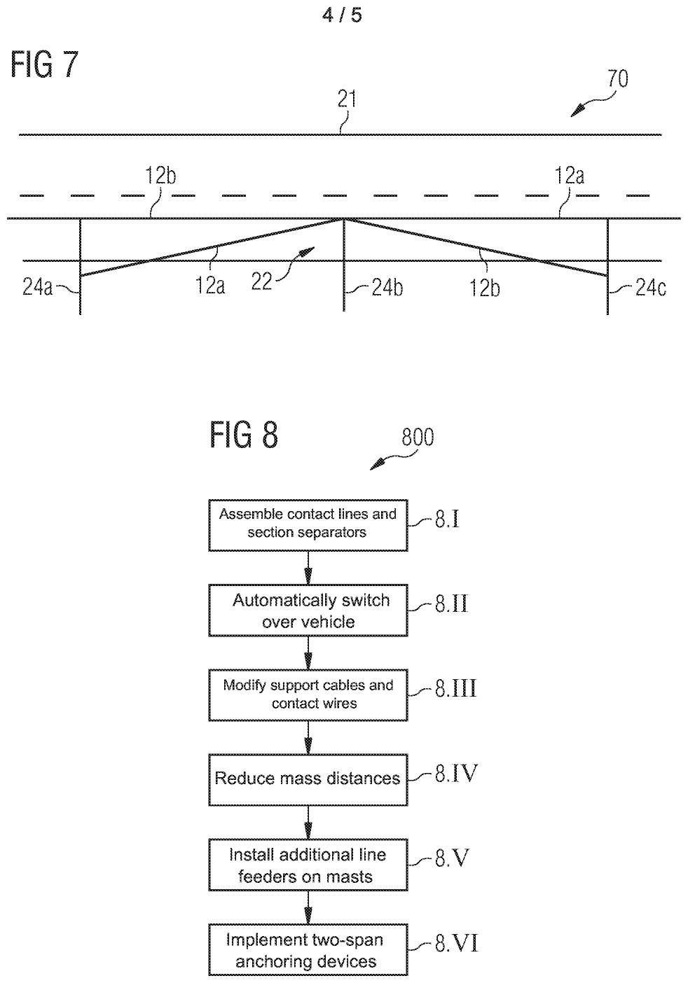

FIG. 7 shows a plan view of a two-span anchoring device without parallel spans,

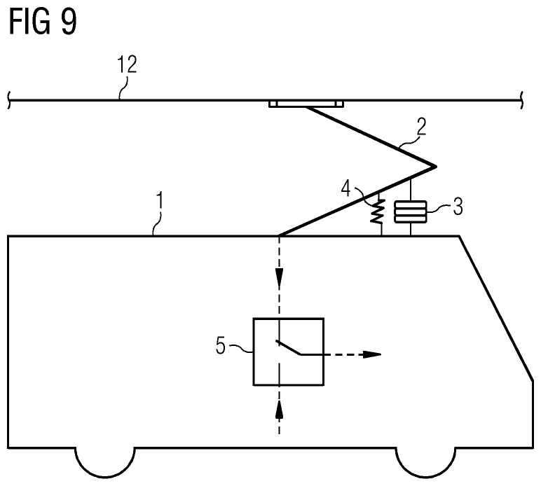

FIG. 8 shows a flow chart, which illustrates a method for stabilizing a contact line system of an electrified road transport system according to one exemplary embodiment of the invention.

FIG. 1 shows a conventional arrangement of what is known as a section separator 15 in a side view 10a and a plan view 10b. Section separators are used to separate different feed sections of a contact line network from each other. The section separator 15 is suspended on a support cable 11 with the aid of suspension units 14. The suspension units 14 are stabilized in the horizontal direction by a longitudinal stabilizer 13. A contact wire of a different feed section is arranged at the two ends of the section separator respectively. The two contact wires are electrically insulated from each other by the section separator.

FIG. 2 shows a side view of an arrangement 20 of a section separator 15 according to one exemplary embodiment of the invention. As can be seen in FIG. 3 and FIG. 4, an arrangement 20 of a section separator 15 is shown in a curve region. The section separator 15 is not suspended on a support cable 11 as in the conventional arrangement in FIG. 1 but is suspended with the aid of two suspension cables 14a directly on a cantilever 24 of an overhead line mast 23. The two suspension cables 14a and the section separator 15 form an isosceles triangle. Also connected to the cantilever 24 of the overhead line mast 23 are support cables 11, on which contact wires 12 are suspended with the aid of vertically-running suspension cables 25. For the sake of simplicity, only one contact wire 12 respectively is shown in FIG. 2 to FIG. 7 for one lane. This is intended to symbolize two parallel contact wires with different polarity, however. As already mentioned, two parallel direct current lines with different polarity are used in electrified road transport systems to supply power. The support cables 11 together with the suspension cables 25 and the contact wires 12 form a chain mechanism. The two illustrated contact wires 12 are separated from each other by the section separator 15. The section separator 15 is better protected against undesired movements by the direct suspension of the section separator 15 on the cantilever 24. A movement of the overhead line is therefore also reduced when the section separator is in contact with a pantograph of a vehicle. A lateral movement can be prevented by a side holder 26 designed as a cantilever (see FIG. 4), so the section separator 15 is also not moved in the lateral direction when in contact with the pantograph.

FIG. 3 shows a plan view of the arrangement 20 of a section separator 15 illustrated in FIG. 2 in a curve. A curved section of a road having two lanes can be seen schematically in FIG. 3, with an overhead line being tensioned over a lane 22 by way of example. For this purpose, support cables 11 are arranged on cantilevers 24, on which cables contact wires 12 are suspended with the aid of suspension cables 25. The two illustrated contact wires 12 are electrically separated from each other by the section separator 15 already shown in FIG. 2. As already mentioned, the section separator 15 is also suspended on a cantilever 24. The contact wires 12, together with the support cables 11 and suspension cables 25, form a skewed arrangement for improved stabilization. In the case of such a skewed arrangement, the support cables 11 are arranged so as to be offset, viewed in the transverse direction, on cantilevers of adjacent overhead line masts, so in plan view there is a zig-zag course of the support cables 11. The contact wires 12 themselves are not arranged in a zig-zag manner, but follow the course of the road 21, wherein they form chords of a curve section running between two overhead line masts. It should be noted once again in this connection that with the two-pole arrangement conventional in electrified road systems, two contact wires having different poles respectively are tensioned in parallel and in the inventive embodiment these are designed therefore with additional, parallel second overhead lines having contact wires, support cables and suspension cables running parallel to contact wires, support cables and suspension cables shown in FIG. 2 to FIG. 7.

FIG. 4 shows a perspective view of the arrangement 20, illustrated in FIG. 2 and FIG. 3, of a section separator 15 in a curve. As can be seen in FIG. 4, in addition to the cantilevers 24 of the overhead line masts 23, on which both the section separator 15 and the support cables 11 are suspended, side holders 26 are mounted on the overhead line masts 23, which stabilize the contact wires 12 and the section separator 15 in the lateral direction. The skewed arrangement of the overhead line can also be seen in the perspective view of FIG. 4, and this is achieved in that the position of the suspension of the support cables 11 on the cantilevers 24 varies in the transverse direction.

A skewed arrangement of an overhead line is also possible on straight-running section segments. FIG. 5 and FIG. 6 show an arrangement 50 of this kind. FIG. 5 shows a plan view of a straight section segment with an overhead line. The section segment comprises a road 21 with two lanes, with an overhead line being tensioned above a lane 22 by way of example. For this purpose, support cables 11 are arranged on cantilevers 24, on which contact wires 12 are suspended with the aid of suspension cables 25. The contact wires 12 are stabilized by a skewed arrangement of the overhead line for improved stabilization. In the case of such a skewed arrangement, the support cables 11 are arranged so as to be offset, viewed in the transverse direction, on the cantilevers 24 of adjacent overhead lines, so in plan view there is a zig-zag course of the support cables 11. The contact wires 12 themselves are not arranged in a zigzag manner, but follow the course of the road, in other words, they also extend straight ahead above the straight-running road 21.

The arrangement 50 shown in FIG. 5 is illustrated in perspective in FIG. 6. As can be seen in FIG. 6, the support cables are suspended on cantilevers 24 of the overhead line masts 23, with the suspension point being different in the transverse direction with cantilevers 24 of adjacent overhead line masts 23. In addition to the cantilevers 24 of the overhead line masts 23 on which the support cables 11 are suspended, side holders 26 are mounted on the overhead line masts 23 and stabilize the contact wires 12 in the lateral direction. The skewed arrangement of the overhead line can clearly be seen in the perspective view of FIG. 6, and this is achieved in that the position of the suspension of the support cables 11 on the cantilevers 24 vary in the transverse direction. An additional stabilization of the arrangement is achieved by contact wires 12 with smaller cross-sections. Smaller cross-sections lead to smaller targets for wind. In addition, thinner contact wires can also be held better in a straight, definite position by mechanical tension. In order to compensate for the lower current flow through the thinner contact wires 12, what are known as line feeders 27 are fastened to the cantilevers 24, and these are in electrical contact with the support cables 11 of the overhead line at the attachment points.

FIG. 7 shows a plan view of a two-span anchoring device 70 without parallel spans. An arrangement for tensioning contact wires 12a, 12b is to be understood as an anchoring device in this context. In the arrangement shown in FIG. 7, a first contact wire 12a coming from the right is guided diagonally outwards at a cantilever 24b of a central overhead line mast up to a cantilever 24a of a left overhead line mast, away from the road 21 and is anchored on the left overhead line mast. A second homopolar contact wire 12b coming from the left is also guided diagonally outwards at the cantilever 24b of the central overhead line mast, but in this case in the direction of a cantilever 24c of a right-hand overhead line mast. A vehicle coming from the left firstly travels with contact with the second contact wire 12b up to the point at which the cantilever 24b of the central overhead line mast is located. It then travels with contact with the first contact wire 12a further to the right. With this arrangement it is possible to dispense with a parallel span, in other words a parallel guidance of the first and second homopolar contact wires. In this way, the positional tolerance of the pantograph can be reduced in the lateral direction since the arrangement does not have homopolar contact wires which are adjacent in the lateral direction.

FIG. 8 shows a flow chart, illustrating a method for stabilizing a contact line system of an electrified road transport system according to one exemplary embodiment of the invention. In step 8.1, firstly skewed contact line constructions (see FIG. 2 to FIG. 6) are assembled both on straight sections and in curves. Section separators present in curves are positioned on cantilevers of overhead line masts in order to obtain increased stability of the overhead line. The use of the skewed contact line constructions is effected without lengthening the mast distances in order to improve the stability of the positioning of the contact wires. In step 8.II, an automatic switchover of an electrified vehicle is set up, which is triggered when the pantograph of the electrified vehicle no longer has secure contact with the contact wire. The automatic switchover can be carried out, for example, as a function of continuously updated measurement information. This can comprise either directly the current flow which is present or indirect measurement information, for example in respect of a wind speed or the like.

In step 8. III, the support cables and contact wires are modified in respect of better tensibility. The cross-sections of the support cables and the contact wires are reduced in the process, materials are selected and optimized in respect of improved tensile strength and the support cables and the contact wires are subject to higher tensile stress, so the susceptibility of the arrangement to side wind is reduced.

As a further measure, the mast distances between the overhead line masts are reduced in a step 8.IV, and this also reduces the influence of the side winds on the position of the contact wires and support cables.

In step 8.V, additional line feeders (see FIG. 6), which are guided on the overhead line masts, carrying electrical current are installed, with which the cross-sections, reduced in step 8. III, of the support cables and the contact wires, which each carry electrical current, are compensated.

Finally, in step 8.VI, two-span anchoring devices without parallel spans are implemented in the overhead line system. Due to the omission of the parallel spans, the lateral positional tolerance of two adjacent electrically homopolar contact wires, including their lateral movements, is reduced to the lateral positional tolerance of a single contact wire.

A necessary vertical and lateral tolerance range for the contact of a pantograph with the contact wires of an overhead line system is greatly reduced with said measures. The limitation of the tolerance range allows the demands on an adjustment of the pantograph to a position of the contact wires variable in the tolerance range to also be reduced.

The pantograph can therefore be constructed in a simplified manner since fewer actuators can be used to cover the reduced tolerance range. An elimination even of a degree of freedom of movement of the pantograph can potentially be possible in the process. In addition, a simplified spring system can also be used for the pantograph due to the reduction in the tolerance range. The lower level of complexity of the pantograph leads to a smaller number of components, a lower outlay in the production and maintenance of the system, a longer service life of the entire system and to lower operating costs.

In conclusion, it should be pointed out once again that the above-described methods and devices are only preferred exemplary embodiments and that a person skilled in the art can vary the invention without departing from the scope of the invention insofar as it is specified by the claims. As already mentioned, the invention is intended not only for overhead line systems having one line, but preferably also for overhead line systems having two parallel, differently polarized direct current lines. It is also pointed out for the sake of completeness that the use of the indefinite articles “a” or “an” does not preclude the features in question from also being present several times.

1-9. (canceled)

10. An electrified road transport system, comprising:
at least one electrified transport vehicle having a pantograph; and
a contact line system having a plurality of masts and overhead lines suspended on said masts, said overhead lines including support cables and contact wires suspended on said support cables;
said contact line system having structural modifications for reducing at least one of horizontal or vertical positional tolerances of said contact wires, said structural modifications including:
masts or cantilevers of said masts and section separators fastened directly to said masts or said cantilevers; and
said overhead lines being skewed in at least one of straight section segments or curves; and
at least one of said support cables or said contact wires having at least one of reduced cross-sections or increased longitudinal tensile forces.

11. The electrified road transport system according to claim 10, wherein said structural modifications include at least one of:
additional line feeders on said masts or two-span anchoring devices without parallel spans.

12. The electrified road transport system according to claim 11, wherein said section segments with skewed overhead lines have mast distances being unchanged compared to mast distances in straight-running overhead lines.

13. The electrified road transport system according to claim 10, wherein said pantograph of said electrified transport vehicle has a reduced vertical working range.

14. The electrified road transport system according to claim 10, wherein said pantograph of said electrified transport vehicle has a reduced horizontal working range.

15. The electrified road transport system according to claim 10, wherein said pantograph of said electrified transport vehicle has at least one of a reduced vertical or horizontal working range, and said pantograph of said electrified transport vehicle assumes an invariable position in at least one of a lateral or a vertical direction.

16. The electrified road transport system according to claim 10, wherein said pantograph of said electrified transport vehicle has at least one of a reduced vertical or horizontal working range, and said pantograph of said electrified transport vehicle has at least one of a passive air spring system or a passive mechanical spring system for vertical position adjustment.

17. The electrified road transport system according to claim 10, wherein said pantograph of said electrified transport vehicle assumes an invariable position in at least one of a lateral or a vertical direction, and said pantograph of said electrified transport vehicle has at least one of a passive air spring system or a passive mechanical spring system for vertical position adjustment.

18. The electrified road transport system according to claim 10, wherein said electrified transport vehicle has an automatic switching device for changing an energy supply of said electrified transport vehicle, said automatic switching device being triggered when said pantograph of said electrified transport vehicle no longer has a secure contact with said contact wire.

19. A method for stabilizing a contact line system of an electrified road transport system, the method comprising the following steps:
providing at least one electrified transport vehicle having a pantograph;
providing a plurality of masts and overhead lines suspended on the masts, the overhead lines including support cables and contact wires suspended on the support cables; and
structurally modifying the contact line system to reduce horizontal and vertical positional tolerances of the contact wires, the structural modifications including:
fastening section separators directly to the masts or cantilevers of the masts, and
skewing the overhead lines in at least one of straight section segments or curves, and
providing at least one of the support cables or contact wires with at least one of reduced cross-sections or increased longitudinal tensile forces.
